(19) United States
(12) Patent Application Publication
(10) Pub. No.: US 2025/0338015 A1
(43) Pub. Date: Oct. 30, 2025

(54) SOLID-STATE IMAGING ELEMENT AND ELECTRONIC APPARATUS

(71) Applicant: SONY SEMICONDUCTOR SOLUTIONS CORPORATION, KANAGAWA (JP)

(72) Inventor: MAKOTO SHIJO, KANAGAWA (JP)

(21) Appl. No.: 18/879,837

(22) PCT Filed: Jul. 10, 2023
(86) PCT No.: PCT/JP2023/025390

§ 371 Date: Dec. 30, 2024

(30) Foreign Application Priority Data
Jul. 25, 2022 (JP) 2022-118254

(51) Int. Cl. H04N 23/67; H04N 25/533; H04N 25/704; H04N 25/772

(52) U.S. Cl. CPC H04N 23/672; H04N 25/533; H04N 25/704; H04N 25/772

(57) ABSTRACT

Provided are a solid-state imaging element and an electronic apparatus capable of suppressing a decrease in performance of an AF function using a phase difference pixel. According to the present disclosure, there is provided a solid-state imaging element including: first phase difference pixels, each pupil-dividing incident light from a subject and detecting an image plane phase difference; a control circuit that controls driving of the first phase difference pixels; and a signal processing section that converts an analog signal non-destructively read a plurality of times from each of the first phase difference pixels into a digital signal according to control of the control circuit.

### TECHNICAL FIELD

The present disclosure relates to a solid-state imaging element and an electronic apparatus.

### BACKGROUND ART

Conventionally, a focus is controlled by an AF function using a phase difference pixel. Furthermore, in recent years, a voltage domain (VD) has been developed in response to a need for a global shutter (GS). In the voltage domain, random noise (RN) is worse than that of a rolling shutter (RS)-based CMOS image sensor (CIS), and autofarcus (AF) performance at low illuminance may also be deteriorated.

### CITATION LIST

### Patent Document

PATENT DOCUMENT 1 Japanese Patent Application Laid-Open No. 2019-129374

### SUMMARY OF THE INVENTION

### Problems to be Solved by the Invention

Therefore, the present disclosure provides a solid-state imaging element and an electronic apparatus capable of suppressing a decrease in performance of an autofarcus function using a phase difference pixel.

### Solutions to Problems

In order to solve the above problem, according to the present disclosure, there is provided a solid-state imaging element including:
first phase difference pixels, each pupil-dividing incident light from a subject and detecting an image plane phase difference;
a control circuit that controls driving of the first phase difference pixels; and
a signal processing section that converts an analog signal non-destructively read a plurality of times from each of the first phase difference pixels into a digital signal according to control of the control circuit.

The solid-state imaging element may further include a sensor section including a plurality of phase difference pixels including the first phase difference pixels and a plurality of pixels used for imaging.

The control circuit may limit the phase difference pixels to be subjected to non-destructive reading within a predetermined region in the sensor section.

The signal processing section may include:
an analog-to-digital converter that converts an analog signal non-destructively read from each of the first phase difference pixels into a digital signal; and
a data processing section that performs calculation processing on the digital signal converted by the analog-to-digital converter,
the analog-to-digital converter may convert analog signals non-destructively read a plurality of times into digital signals, and
the data processing section may perform addition processing on a plurality of the converted digital signals.

The control circuit may change a number of times of non-destructive reading from the first phase difference pixels.

The control circuit may change a number of times of non-destructive reading from the plurality of pixels.

The control circuit may change a number of times of the non-destructive reading on the basis of an exposure signal related to a light reception amount.

The plurality of phase difference pixels and the plurality of pixels used for imaging may be arranged in a matrix, and
the control circuit may control the phase difference pixels arranged in a same row or a same column and the pixels to accumulate charges according to a light reception amount at different accumulation times.

The signal processing section may include
an analog-to-digital converter that converts an analog signal non-destructively read from each of the first phase difference pixels into a digital signal, and
the analog-to-digital converter may include:
a comparator that compares a level of the non-destructively read analog signal with a predetermined ramp signal and outputs a comparison result; and
a counter section that counts a count value over a period until the comparison result is inverted and outputs the digital signal indicating the count value.

The counter section may add the count value for each of analog signals non-destructively read a plurality of times.

A predetermined range of a light receiving region of each of the first phase difference pixels may be shielded from light.

The first phase difference pixels may include one of two adjacent pixels in which an elliptical on-chip lens is disposed.

The first phase difference pixels may include at least one of four adjacent pixels in which color filters of a same color are disposed.

The first phase difference pixels may include at least one of four adjacent pixels in which one on-chip lens is disposed.

The first phase difference pixels may include at least one of two adjacent square shaped pixels in which one on-chip lens is disposed.

The plurality of pixels may be imaged via a polarization section that changes light.

The signal processing section may include:
an analog-to-digital converter that converts an analog signal non-destructively read from each of the first phase difference pixels into a digital signal; and
a transmission section that transmits the digital signal,
the analog-to-digital converter may convert analog signals non-destructively read a plurality of times into digital signals, and
the transmission section may transmit a plurality of the converted digital signals.

Each of the first phase difference pixels may include:
first and second capacitive elements;
a pre-stage circuit that sequentially generates a predetermined reset level and a signal level according to an exposure amount and causes each of the first and second capacitive elements to hold the reset level and the signal level; and
a post-stage circuit that sequentially reads and outputs the reset level and the signal level from the first and second capacitive elements.

The comparator may compare a level of a signal line that transmits the reset level and the signal level with a predetermined ramp signal, and outputs a comparison result.

In order to solve the above problem, according to the present disclosure, there is provided an electronic apparatus including:
the above-described solid-state imaging element;
a lens that condenses light from a subject and condenses the light on a light receiving surface on which the first phase difference pixels are disposed; and
an imaging control section that controls a focal position of the lens according to a signal generated by the signal processing section.

### BRIEF DESCRIPTION OF DRAWINGS

FIG. 1 is a block diagram illustrating a configuration example of an electronic apparatus according to the present embodiment.

FIG. 2 is a diagram illustrating a configuration example of an electronic device.

FIG. 3A is a diagram illustrating a configuration example of a sensor section.

FIG. 3B is a diagram illustrating another configuration example of the sensor section.

FIG. 3C is a diagram illustrating a configuration example of a sensor section 21 in a quad array.

FIG. 3D is a diagram illustrating a four-pixel configuration example of a quad array.

FIG. 3E is a diagram illustrating a configuration example of a Deca-Octa array.

FIG. 3F is a diagram illustrating a configuration example of a square pixel.

FIG. 3G is a diagram illustrating a configuration example of a quad array using square pixels.

FIG. 3H is a plan view illustrating an arrangement example of a polarization section arranged in a normal pixel.

FIG. 4 is a diagram illustrating an example of phase difference information.

FIG. 5 is a circuit diagram illustrating a specific configuration of a circuit in the electronic device.

FIG. 6 is a circuit diagram illustrating a configuration example of a pixel.

FIG. 7 is a timing chart for explaining the operation of an analog-to-digital converter.

FIG. 8 is a time chart illustrating a processing example in a first mode.

FIG. 9 is a time chart illustrating a processing example in a second mode.

FIG. 10 is a time chart illustrating a processing example in a case where a third mode is executed in addition to the first mode.

FIG. 11 is a time chart illustrating a processing example in a case where a fourth mode is executed.

FIG. 12 is a time chart illustrating an operation example of another passive circuit.

FIG. 13 is a diagram illustrating a schematic configuration of a solid-state imaging device according to a second embodiment.

FIG. 14 is a block diagram illustrating an example of a schematic configuration of a vehicle control system.

FIG. 15 is an explanatory diagram illustrating an example of installation positions of an outside-vehicle information detection section and an imaging section.

FIG. 16 is a diagram schematically illustrating an overall configuration of an operating room system.

### MODE FOR CARRYING OUT THE INVENTION

Hereinafter, preferred embodiments of the present disclosure will be described in detail with reference to the accompanying drawings. Note that, in the present specification and drawings, components having substantially the same functional configuration are denoted by the same reference signs, and redundant description is omitted.

### One Embodiment

### [Configuration Example of Electronic Apparatus]

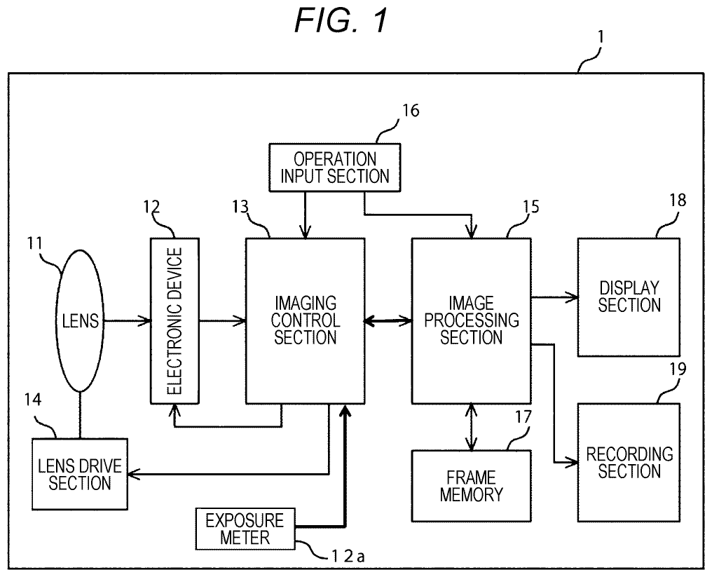

FIG. 1 is a block diagram illustrating a configuration example of an electronic apparatus 1 according to the present embodiment. The electronic apparatus 1 is, for example, an apparatus capable of capturing an image. That is, the electronic apparatus 1 includes a lens 11, an electronic device 12, an exposure meter 12a, an imaging control section 13, a lens drive section 14, an image processing section 15, an operation input section 16, a frame memory 17, a display section 18, and a recording section 19. As the electronic apparatus 1, for example, a digital camera, a smartphone, a personal computer, a vehicle-mounted camera, or an Internet of Things (IoT) camera is assumed.

The lens 11 is an imaging lens of the electronic apparatus 1. The lens 11 condenses light from a subject and causes the light to enter the electronic device 12 described later to form an image of the subject.

The electronic device 12 is a solid-state imaging element that images light from the subject collected by the lens 11. The electronic device 12 is a device capable of non-destructively reading a signal from a pixel. That is, the electronic device 12 generates an analog image signal according to the emitted light, converts the image signal into a digital image signal, and outputs the digital image signal. Note that details of the electronic device 12 will be described later.

The exposure meter 12a is used for exposure control of the electronic device 12. The exposure meter 12a can output a light amount in an image capturing environment as an exposure value. The exposure meter 12a outputs an exposure signal including information regarding a light amount to the imaging control section 13.

The imaging control section 13 controls imaging in the electronic device 12. The imaging control section 13 controls the electronic device 12 by generating a control signal and outputting the control signal to the electronic device 12. The imaging control section 13 can change drive control of the electronic device 12 on the basis of the exposure signal. Furthermore, the imaging control section 13 changes the number of times of non-destructive reading of signals from the pixels according to, for example, exposure. Moreover, for example, the imaging control section 13 increases the number of times of non-destructive reading as the exposure becomes lower. In this case, random noise can be reduced by adding and averaging the image signals multiplexed and read by non-destructive reading.

Furthermore, the imaging control section 13 can perform autofocus in the electronic apparatus 1 on the basis of an image signal output from the electronic device 12. Here, the autofocus is a system that detects a focal position of the lens 11 and automatically adjusts the focal position. As the autofocus, a method (image plane phase difference autofocus) of detecting the focal position by detecting an image plane phase difference using a phase difference pixel disposed in the electronic device 12 can be used. Furthermore, a method of detecting a position in which contrast of an image is the highest as the focal position (contrast autofocus) may also be applied. The imaging control section 13 adjusts the position of the lens 11 via the lens drive section 14 on the basis of the detected focal position, and performs autofocus. Note that the imaging control section 13 can include, for example, a digital signal processor (DSP) equipped with firmware.

The lens drive section 14 drives the lens 11 on the basis of the control of the imaging control section 13. The lens drive section 14 can drive the lens 11 by changing a position of the lens 11 using a built-in motor.

The image processing section 15 processes an image signal generated by the electronic device 12. This processing includes, for example, demosaicing of generating an image signal of a lacking color among the image signals corresponding to red, green, and blue for each pixel, noise reduction of removing noise of the image signal, encoding of the image signal and the like.

Furthermore, the image processing section 15 can perform recognition processing of a subject region using the processed image signal. For this recognition processing, a general recognition processing algorithm can be used. The image processing section 15 outputs a region signal including information of the subject region to the imaging control section 13. As a result, the imaging control section 13 limits a reading range of the electronic device 12 on the basis of the information of the subject region. The image processing section 15 can include, for example, a microcomputer equipped with firmware.

The operation input section 16 receives an operation input from a user of the electronic apparatus 1. As the operation input section 16, for example, a push button or a touch panel can be used. The operation input received by the operation input section 16 is transmitted to the imaging control section 13 and the image processing section 15. Thereafter, processing according to the operation input, for example, processing such as imaging of the subject is started. Furthermore, the user of the electronic apparatus 1 can also designate the reading range of the electronic device 12 via the operation input section 16. In this case, the imaging control section 13 can also limit the reading range of the electronic device 12 on the basis of the range designated via the operation input section 16.

The frame memory 17 is a memory that stores a frame that is an image signal for one screen. The frame memory 17 is controlled by the image processing section 15 and holds frames in the process of image processing.

The display section 18 displays an image processed by the image processing section 15. For example, a liquid crystal panel can be used as the display section 18.

The recording section 19 records the image processed by the image processing section 15. For example, a memory card or a hard disk can be used as the recording section 19.

### [Configuration Example of Electronic Device 12]

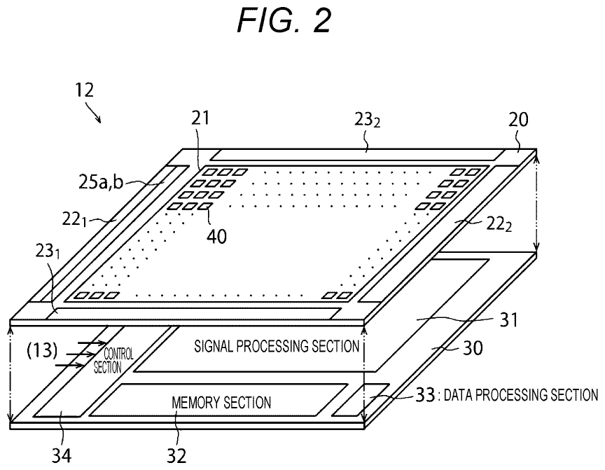

FIG. 2 is a diagram illustrating a configuration example of the electronic device 12. As illustrated in FIG. 2, the electronic device 12 is an imaging device capable of non-destructive readout of a voltage domain (VD).

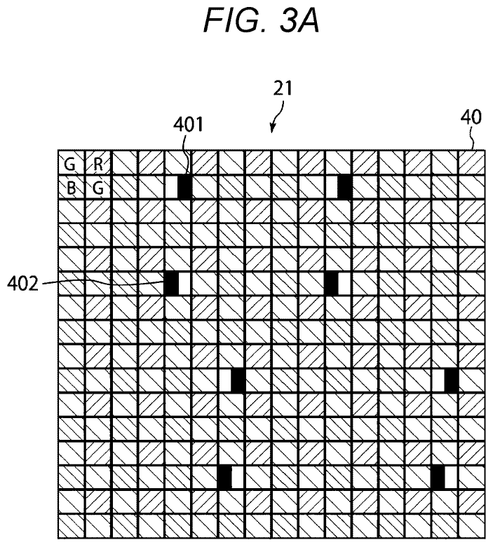

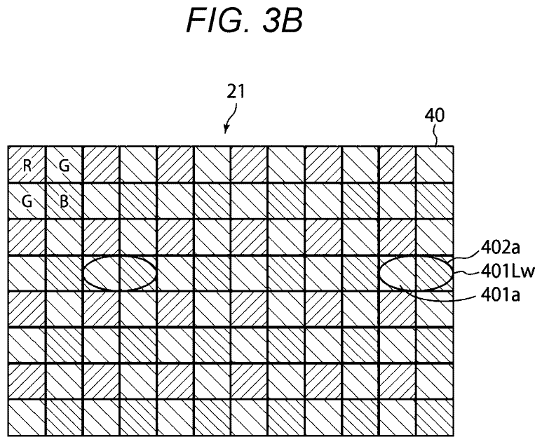

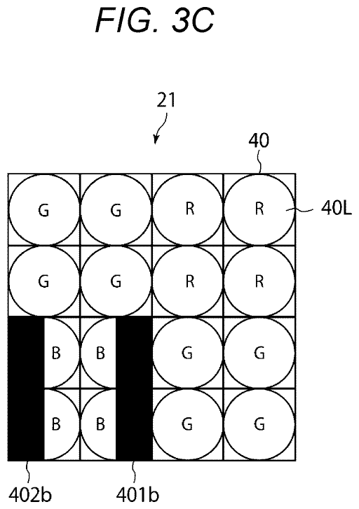

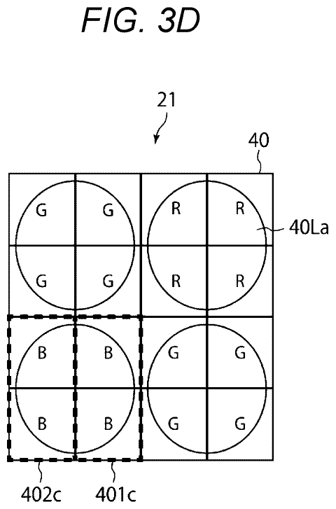

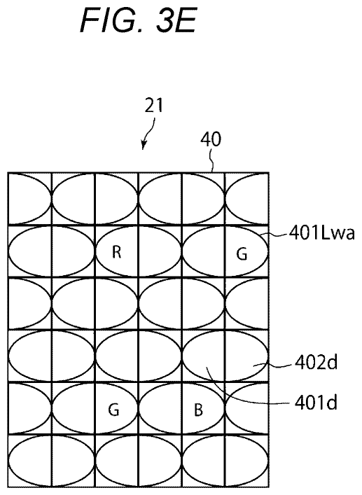

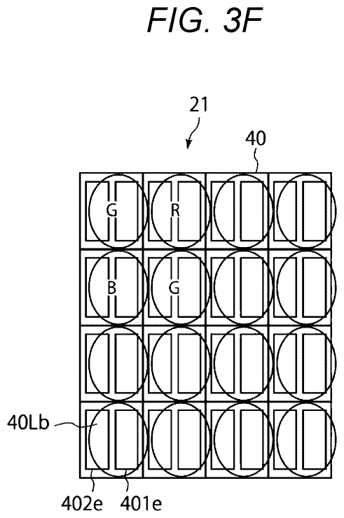

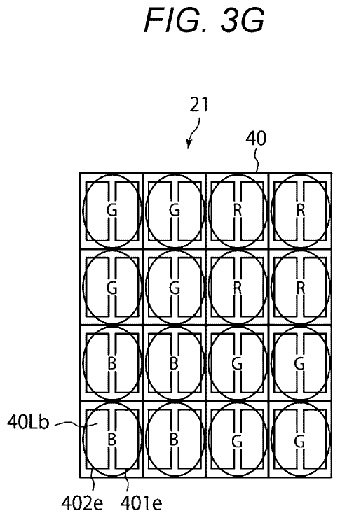

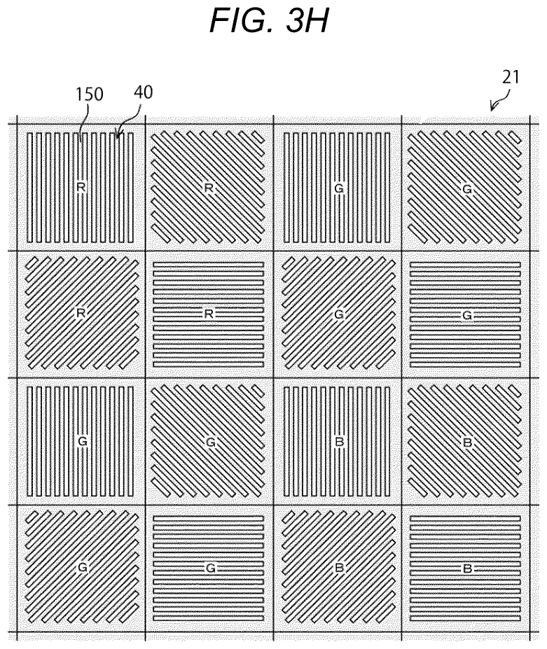

The electronic device 12 includes a first semiconductor chip 20 and a second semiconductor chip 30. The first semiconductor chip 20 includes a sensor section 21 in which a plurality of normal pixels 40 and a plurality of phase difference pixels 401 and 402 (see FIG. 3A) are arranged, and vertical selection circuits 25a and b that drive and control the sensor section 21. The vertical selection circuit 25a drives and controls the plurality of normal pixels 40. On the other hand, the vertical selection circuit 25b drives and controls the plurality of phase difference pixels 401 and 402 (see FIG. 3A). Note that the vertical selection circuits 25a and b according to the present embodiment correspond to a control circuit.

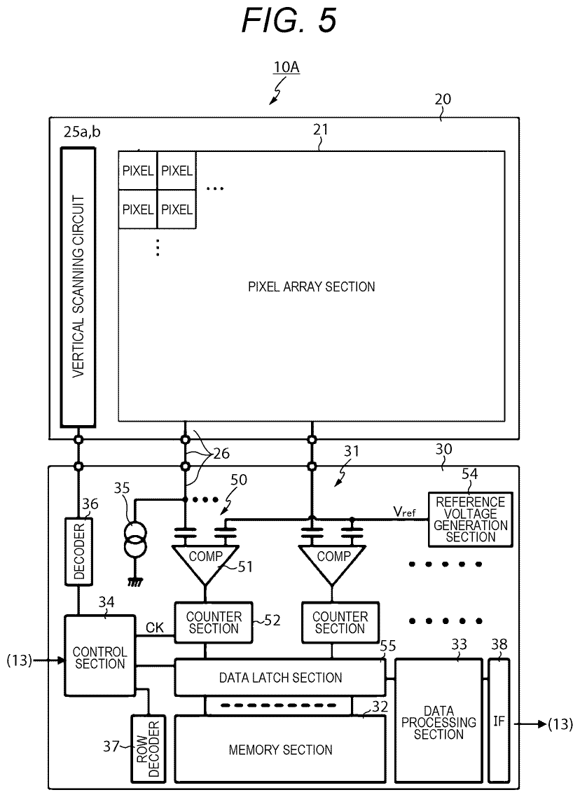

The second semiconductor chip 30 includes a signal processing section 31, a memory section 32, a data processing section 33, a control section 34, and an interface section (IF) 38 (see FIG. 5 described later). The image processes signals acquired by the plurality of normal pixels 40 and the plurality of phase difference pixels 401 and 402 (see FIG. 3). The memory section 32 stores signals generated by the electronic device 12 including pixel signals. The data processing section 33 reads the image data stored in the memory section 32 in a predetermined order, performs various processing, and outputs the image data to the outside of the chip. The interface section 38 is a communication interface with the imaging control section 13 (see FIG. 1). The control section 34 controls the entire electronic device 12 under the control of the imaging control section 13. Note that the vertical selection circuits 25a and b according to the present embodiment correspond to a control circuit. Note that the interface section 38 according to the present embodiment corresponds to a transmission section.

On a peripheral edge portion of the first semiconductor chip 20, pad portions 221 and 222 for performing electrical connection with the outside and via portions 231 and 232 having a TC(S) V structure for performing electrical connection with the second semiconductor chip 30 are provided.

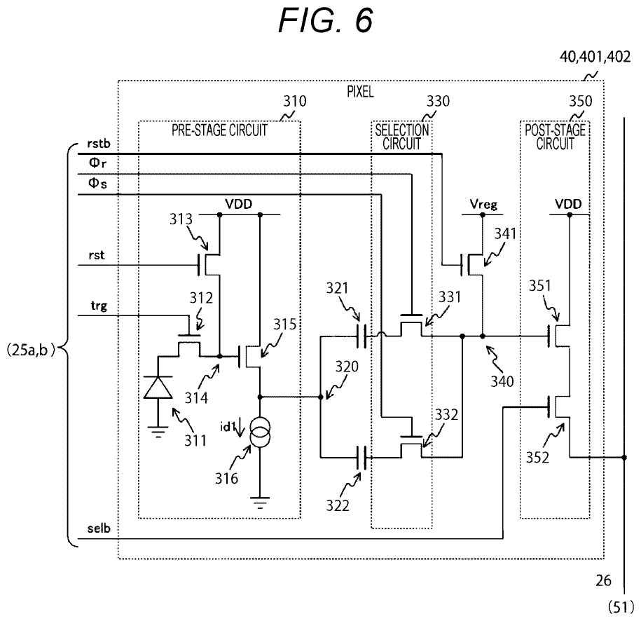

Here, a configuration example of the sensor section 21 will be described with reference to FIGS. 3A to 3H. Each pixel in the following description has an equivalent circuit configuration, for example, as illustrated in FIG. 6 to be described later.

FIG. 3A is a diagram illustrating a configuration example of the sensor section 21. As illustrated in FIG. 3A, the sensor section 21 includes the plurality of normal pixels 40 and the plurality of phase difference pixels 401 and 402. Note that the phase difference pixel according to the present embodiment may be referred to as a phase detection auto focus (PDAF) pixel. The plurality of normal pixels 40 and the plurality of phase difference pixels 401 and 402 are arranged in a two-dimensional matrix (matrix). In the normal pixels 40, for example, color filters red (R), green (G), and blue (B) are disposed in a Bayer array. More specifically, the normal pixels 40 in which “R”, “G”, and “B” are described represent the normal pixels 40 in which color filters that transmit red light, green light, and blue light are arranged, respectively. In the following description, “R”, “G”, and “B” indicate color filters that transmit red light, green light, and blue light, respectively.

The phase difference pixels 401 and 402 are pixels that detect an image plane phase difference of a subject by performing pupil division on the subject. The phase difference pixels 401 and 402 pupil-divide the subject in a left-right direction of the drawing. More specifically, in the phase difference pixels 401 and 402, a right side and a left side of a photoelectric conversion section are shielded from the light, respectively. A plurality of such phase difference pixels 401 and 402 are arranged in the sensor section 21. Furthermore, in the present embodiment, an example of pupil-dividing the subject in the left-right direction of the screen will be described, but the present disclosure is not limited thereto. For example, the subject may be subjected to pupil division in a vertical direction of the screen.

FIG. 3B is a diagram illustrating another configuration example of the sensor section 21. As illustrated in FIG. 3B, the sensor section 21 includes the plurality of normal pixels 40 and a plurality of phase difference pixels (PDAF) 401a and 402a. The normal pixels 40 are arranged in a two-dimensional matrix (matrix). In the normal pixels 40, for example, color filters red (R), green (G), and blue (B) are arranged in a Bayer array. Furthermore, an on-chip lens (not illustrated) is disposed in each normal pixel 40.

In the phase difference pixel (PDAF) 401a, a color filter green (G) is disposed instead of the color filter blue (B) arranged in a Bayer array. Then, elliptical on-chip lenses are disposed in the phase difference pixels (PDAF) 401a and 402a. The phase difference pixels (PDAF) 401a and 402a pupil-divide the subject in the left-right direction of the drawing.

FIG. 3C is a diagram illustrating a configuration example of the sensor section 21 in a Quad array. As illustrated in FIG. 3C, the sensor section 21 includes the plurality of normal pixels 40 and a plurality of phase difference pixels (PDAF) 401b and 402b. FIG. 3C is an example of a Quad array in which color filters red (R), green (G), and blue (B) are arranged in units of four pixels. An on-chip lens 40L is disposed in each pixel.

The phase difference pixels 401b and 402b are configured as pixels in which the color filter blue (B) is disposed, for example. In the phase difference pixels 401b and 402b, the right side and the left side of the photoelectric conversion section are shielded from light, respectively. As a result, the phase difference pixels (PDAF) 401b and 402b pupil-divide the subject in the left-right direction of the drawing.

FIG. 3D is a diagram illustrating a four-pixel configuration example of a Quad array. As illustrated in FIG. 3D, the sensor section 21 includes the plurality of normal pixels 40 and a plurality of phase difference pixels (PDAF) 401c and 402c. FIG. 3D is an example of a Quad array in which color filters red (R), green (G), and blue (B) are arranged in units of four pixels. An on-chip lens 40La is disposed in units of four pixels. For example, the normal pixel is configured by adding output values of four pixels.

The phase difference pixels 401c and 402c are configured as pixels in which the color filter blue (B) is disposed, for example. The phase difference pixels 401c and 402c are equivalent to the case where the right side and the left side of the photoelectric conversion section are shielded from light, respectively. The phase difference pixels (PDAF) 401c and 402c pupil-divide the subject in the left-right direction of the drawing. The phase difference pixel 401c is configured by adding output values of, for example, two pixels on the left side of the four pixels. Furthermore, the phase difference pixel 402c is configured by adding output values of, for example, two pixels on the right side of the four pixels.

FIG. 3E is a diagram illustrating a configuration example of a Deca-Octa array. As illustrated in FIG. 3E, the sensor section 21 includes the plurality of normal pixels 40 and a plurality of phase difference pixels (PDAF) 401d and 402d. FIG. 3E is an example of a Quad array in which color filters red (R), green (G), and blue (B) are arranged in units of four pixels. An elliptical on-chip lens 401Lwa is disposed in two pixel units. For example, the normal pixel is configured by adding output values of the two pixels disposed with the elliptical on-chip lens 401Lwa.

The phase difference pixels 401d and 402d are configured as pixels in which the color filter blue (B) is disposed, for example. The phase difference pixels 401d and 402d are equivalent to the case where the right side and the left side of the photoelectric conversion section are shielded from light, respectively. The phase difference pixels (PDAF) 401d and 402d pupil-divide the subject in the left-right direction of the drawing. The phase difference pixel 401d includes, for example, the left side of two pixels in which the on-chip lens 401Lwa is disposed. The phase difference pixel 402c includes, for example, the right side of the two pixels in which the on-chip lens 401Lwa is disposed.

FIG. 3F is a diagram illustrating a configuration example of a square (Recta) pixel. As illustrated in FIG. 3F, the sensor section 21 includes the plurality of normal pixels 40 and a plurality of phase difference pixels (PDAF) 401e and 402e. FIG. 3F is an example of a Bayer array in which color filters red (R), green (G), blue (B), and the on-chip lenses 40Lb are arranged for every two square (Recta) pixels. For example, the normal pixel is configured by adding output values of two square pixels in which the on-chip lens 40Lb is disposed.

The phase difference pixels 401e and 402e are configured as pixels in which the color filter blue (B) is disposed, for example. The phase difference pixels 401e and 402e are equivalent to the case where the left side and the right side of the photoelectric conversion section are shielded from light, respectively. The phase difference pixels (PDAF) 401e and 402e pupil-divide the subject in the left-right direction of the drawing. The phase difference pixel 401e includes, for example, the right side of two square pixels in which the on-chip lens 40Lb is disposed. The phase difference pixel 402e includes, for example, the left side of two square pixels in which the on-chip lens 40Lb is disposed.

FIG. 3G is a diagram illustrating a configuration example of a Quad array using square (Recta) pixels. As illustrated in FIG. 3G, the sensor section 21 includes the plurality of normal pixels 40 and the plurality of phase difference pixels (PDAF) 401e and 402e. For example, the normal pixel 40 is configured by adding output values of two square pixels disposed with the on-chip lens 40Lb.

The phase difference pixels 401e and 402e are configured as pixels in which the color filter blue (B) is disposed, for example. The phase difference pixels 401e and 402e are equivalent to the case where the left side and the right side of the photoelectric conversion section are shielded from light, respectively. The phase difference pixels (PDAF) 401e and 402e pupil-divide the subject in the left-right direction of the drawing. The phase difference pixel 401e includes, for example, the right side of the two pixels in which the on-chip lens 40Lb is disposed. The phase difference pixel 402e includes, for example, the left side of the two pixels in which the on-chip lens 40Lb is disposed.

FIG. 3H is a plan view illustrating an arrangement example of a polarization section 150 arranged in the normal pixel 40. A rectangle in the drawing represents the pixel 40, and characters “R”, “G”, and “B” described for each pixel 40 in the drawing represent types of color filters disposed in the pixel 40. The polarization section 150 represents an example of a polarization section including, for example, a wire grid. The wire grid is a polarization section configured by arranging a plurality of strip-shaped conductors at a predetermined pitch. Here, each of the strip-shaped conductors is a conductor formed in a linear shape, a rectangular parallelepiped shape, or the like. Free electrons in the strip-shaped conductor vibrate following an electric field of light incident on the strip-shaped conductor, and radiate a reflected wave. The incident light in a direction perpendicular to a direction in which the plurality of strip-shaped conductors is arranged, that is, parallel to a longitudinal direction of the strip-shaped conductor radiates more reflected light because an amplitude of the free electrons increases. Therefore, the incident light in the direction is reflected without passing through the polarization section 150. On the other hand, in the light perpendicular to the longitudinal direction of the strip-shaped conductor, the radiation of the reflected light from the strip-shaped conductor is reduced. This is because the vibration of the free electrons is limited and the amplitude is reduced. The attenuation of the incident light in the polarization direction by the polarization section 150 is reduced, and the incident light can be transmitted through the polarization section 150. As described above, the polarization section 150 can be further disposed in each pixel of FIGS. 3A to 3G. Note that the configuration of the pixel is not limited to this example. For example, it is also possible to omit the color filter and perform monochrome imaging.

### [Phase Difference Information]

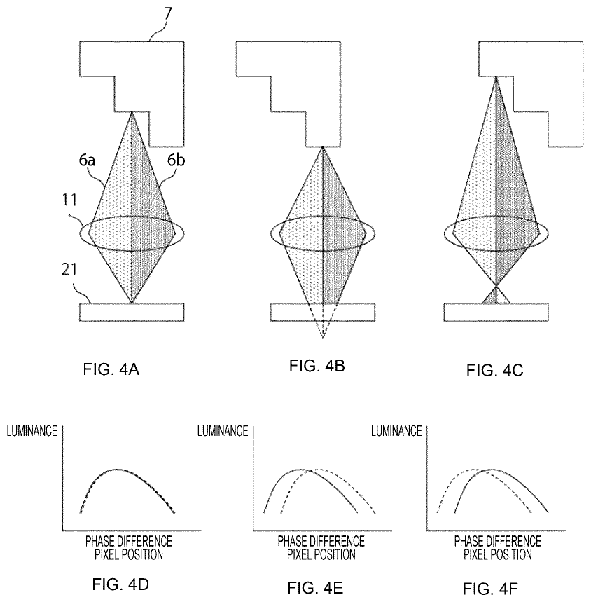

FIG. 4 is a diagram illustrating an example of phase difference information. A to C in FIG. 4 are diagrams illustrating a relationship among a subject 7, the lens 11, and the sensor section 21 when the phase difference is detected. Furthermore, incident lights 6a and 6b in A to C in the drawing represent incident lights incident on the phase difference pixel 402 in which an opening is disposed on the right side of the pixel and the phase difference pixel 401 in which an opening is disposed on the left side of the pixel, respectively. In the following description, the phase difference pixels 401 to 401e may be simply referred to as pixel 401, and the phase difference pixels 402 to 402e may be simply referred to as pixel 402. Similarly, the normal pixel 40 may be simply referred to as pixel 40.

A of the drawing is a diagram illustrating a case where a surface of the subject 7 at the focal position of the lens 11 is imaged. In this case, the incident lights 6a and 6b are condensed on a light receiving surface of the sensor section 21. B of the drawing is a diagram illustrating a case where the surface of the subject 7 at a position closer than the focal position of the lens 11 is imaged. The incident lights 6a and 6b are condensed on a rear side of the sensor section 21, and are in a so-called rear pin state. Therefore, an image is captured with a shift on the light receiving surface of the sensor section 21. C of the drawing is a diagram illustrating a case where the surface of the subject 7 at a position farther than the focal position of the lens 11 is imaged. The incident lights 6a and 6b are condensed at a position closer to the lens 11 than the light receiving surface of the sensor section 21, and are in a so-called front pin state. As compared with B in the drawing, the image is captured while shifted in an opposite direction. In this manner, the condensing position changes according to the position of the subject, and the image is shifted and captured.

Furthermore, D to F in the drawing are diagrams illustrating images in a case where the subject is imaged, and are diagrams illustrating a relationship between a phase difference pixel position and luminance. Furthermore, D to F in the drawing are diagrams illustrating cases where imaging is performed corresponding to the positional relationships of A to C in the drawing, respectively. Here, the phase difference pixel position represents positions of the plurality of phase difference pixels 401 and 402 and the like arranged in the same row of the sensor section 21. Furthermore, solid lines and broken lines in D to F in the drawing are images based on the incident light 6a and 6b, respectively, and are images by the phase difference pixel 402 in which the opening is disposed on the right side of the pixel and the phase difference pixel 401 in which the opening is disposed on the left side of the pixel.

The imaging control section 13 (see FIG. 1) generates phase difference information from image signals of the phase difference pixels 401 and 402 and the like. Using the image plane phase difference information, the imaging control section 13 controls the lens drive section 14 such that the lens 11 is disposed at a predetermined focal length as illustrated in Fig. A.

Here, a more detailed configuration of the electronic device 12 will be described with reference to FIGS. 5 to 7. The electronic device 12 includes a control system capable of independent control of two systems of a normal pixels 40 system and a phase difference pixel 401 and 402 system.

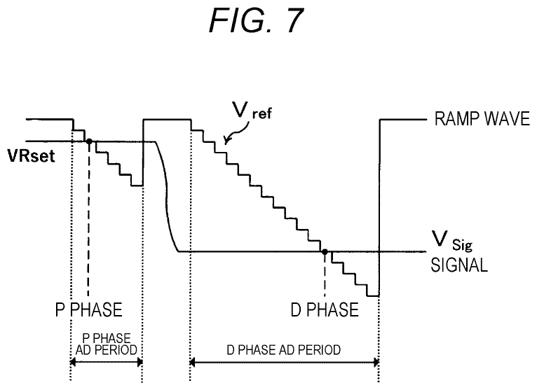

FIG. 5 is a circuit diagram illustrating specific configurations of a circuit on a first semiconductor chip side and a circuit on a second semiconductor chip side in the electronic device 12. FIG. 6 is a circuit diagram illustrating a configuration example of the pixels 40, 401, and 402. FIG. 7 is a timing chart for explaining the operation of an analog-to-digital converter in the electronic device 12.

As illustrated in FIG. 5, the sensor section 21 and the vertical selection circuits 25a and b are disposed on the first semiconductor chip 20. As described above, the vertical selection circuit 25a controls charge accumulation and reading of the plurality of normal pixels 40. On the other hand, the vertical selection circuit 25b controls charge accumulation and reading of the plurality of phase difference pixels 401 and 402.

The signal processing section 31 includes an analog-to-digital converter 50 including a comparator 51 and a counter section 52, a ramp voltage generator 54, a data latch section 55, the memory section 32, the data processing section 33, the control section 34 (including a clock supply section connected to the AD converter 50), a current source 35, a decoder 36, a row decoder 37, and the interface (IF) section 38. Note that the analog-to-digital converter may be abbreviated as an AD converter, and the ramp voltage generator 54 may be referred to as a reference voltage generation section.

The memory section 32 stores image data subjected to predetermined signal processing in the signal processing section 31. The memory section 32 may include a nonvolatile memory or a volatile memory. As described above, the data processing section 33 reads the image data stored in the memory section 32 in a predetermined order, performs various processing, and outputs the image data to the outside of the chip. The control section 34 controls each operation of the signal processing section 31 such as the sensor drive section, the memory section 32, and the data processing section 33 on the basis of a reference signal from the outside of the chip, for example.

Each of signal lines 26 through which an analog signal is read from each pixel of the sensor section 21 for each sensor column is connected to the current source 35. The current source 35 has, for example, a so-called load MOS circuit configuration including a MOS transistor whose gate potential is biased to a constant potential so as to supply a certain constant current to the signal line 26. The current source 35 including the load MOS circuit supplies a constant current to an amplification transistor 351 of the pixels 40, 401, and 402 included in the selected row, thereby operating the amplification transistor 351 as a source follower. When each of the pixels 40, 401, and 402 of the sensor section 21 is selected in units of rows under the control of the control section 34, the decoder 36 provides an address signal designating an address of the selected row to the vertical selection circuit 25. Under the control of the control section 34, the row decoder 37 designates a row address for writing image data into the memory section 32 or reading image data from the memory section 32.

The signal processing section 31 further includes the ramp voltage generator (reference voltage generation section) 54 that generates a reference voltage Vref used at the time of AD conversion in the AD converter 50. The reference voltage generation section 54 generates the reference voltage Vref having a so-called ramp (RAMP) waveform (inclined waveform) in which a voltage value changes stepwise as time elapses.

The AD converter 50 is provided, for example, for each sensor row of the sensor section 21, that is, for each signal line 26. More specifically, the AD converter 50 performs AD conversion on the analog signal read from each of the pixels 40, 401, and 402 of the sensor section 21 to the signal line 26, and transfers the AD-converted image data (digital data) to the memory section 32.

For example, the AD converter 50 generates a pulse signal having a magnitude (pulse width) in a time axis direction corresponding to a magnitude of the level of the analog signal, and measures a length of the period of the pulse width of the pulse signal to perform the AD conversion processing. More specifically, as illustrated in FIG. 5, the AD converter 50 includes at least the comparator (COMP) 51 and the counter section 52. The comparator 51 uses analog signals (the “reset level” and the “signal level” described above) read from the respective pixels 40, 401, and 402 of the sensor section 21 via the signal line 26 as comparison inputs, and uses the reference voltage Vref of the ramp waveform supplied from the reference voltage generation section 54 as a reference input, and compares both inputs. Then, the output of the comparator 51 enters a first state (for example, high level), for example, when the reference voltage Vref becomes larger than the analog signal. Whereas, when the reference voltage Vref is less than or equal to the analog signal, the output is in a second state (for example, a low level). The output signal of the comparator 51 is a pulse signal having a pulse width corresponding to the magnitude of the level of the analog signal.

As illustrated in FIG. 7, for example, an up/down counter is used as the counter section 52. A clock CK is provided to the counter section 52 at the same timing as a supply start timing of the reference voltage Vref to the comparator 51. The counter section 52, which is the up/down counter, performs a down (DOWN) count or an up (UP) count in synchronization with the clock CK, thereby measuring a period of the pulse width of the output pulse of the comparator 51, that is, a comparison period from the start of the comparison operation to the end of the comparison operation. At this time, the counter section 52 performs counting using a reference clock PLLCK until the levels of the analog signal (signal level VSig) and the reference signal Vref intersect and the output of the comparator 51 is inverted.

At the time of this measurement operation, the counter section 52 counts down a reset level VRset and counts up the signal level VSig with respect to the reset level (VRset) and the signal level (VSig) sequentially read from the pixels 40, 401, and 402. Then, a difference between the signal level VSig and the reset level VRset can be obtained by the down count/up count operation. As a result, in the AD converter 50, correlated double sampling (CDS) processing is performed in addition to the AD conversion processing. Here, the “CDS processing” is processing of removing fixed pattern noise unique to the sensor such as reset noise of the pixels 40, 401, and 402 and threshold variation of the amplification transistor 351 by obtaining a difference between the “signal level”) and the “reset level. Then, a count result (count value) of the counter section 52 becomes a digital value (image data) obtained by digitizing the analog signal.

As described above, the AD conversion is performed twice by reading the analog signal once. That is, in the first time, AD conversion of a reset level (P phase) of the pixels 40, 401, and 402 is executed. The reset level P phase includes variation for each sensor. In the second time, the analog signal obtained in each of the pixels 40, 401, and 402 is read to the signal line 26 (D phase), and AD conversion is executed.

Furthermore, the data processing section 33 can have a processing function equivalent to that of the image processing section 15 (see FIG. 1). As a result, it is also possible to perform subject recognition processing in the electronic device. In this case, the region signal of the subject is output to the outside of the second semiconductor chip 30 via the interface section 38.

In the above description, one AD converter 50 in column parallel is provided, but the present disclosure is not limited thereto, and two or more AD converters 50 may be provided, and the two or more AD converters 50 may perform digitization processing in parallel. In this case, the plurality of normal pixels 40 and the plurality of phase difference pixels 401 and 402 can be divided into two groups.

The two or more AD converters 50 can be separately disposed in a direction in which the signal line 26 of the sensor section 21 extends, for example, on both upper and lower sides of the sensor section 21. In a case where the two or more AD converters 50 are provided, two or more data latch sections 55, memory sections 32, and the like (two systems, a normal pixel 40 system and a phase difference pixel 401 and 402 system) may be provided correspondingly. As described above, in an electronic device in which, for example, two systems of the AD converters 50 and the like are provided, row scanning can be performed in units of the normal pixel 40 system and the phase difference pixel 401 and 402 system. Then, one analog signal of each of the normal pixels 40 may be read out to one side in the vertical direction of the sensor section 21, and the other analog signal of each of the phase difference pixels 401 and 402 may be read out to the other side in the vertical direction of the sensor section 21, and the two AD converters 50 may perform digitization processing in parallel. Subsequent signal processing is also performed in parallel. As a result, image data can be read by dividing one sensor into the two systems, the normal pixel 40 system and the phase difference pixel 401 and 402 system.

### [Configuration Example of Pixel]

As illustrated in FIG. 6, the pixels 40, 401, and 402 include a pre-stage circuit 310, capacitive elements 321 and 322, a selection circuit 330, a post-stage reset transistor 341, and a post-stage circuit 350. Each signal of the pixels 40 is supplied from the vertical selection circuit 25a, and each signal of the pixels 401 and 402 is supplied from the vertical selection circuit 25b.

The pre-stage circuit 310 includes a photoelectric conversion element 311, a transfer transistor 312, a floating diffusion (FD) reset transistor 313, an FD 314, a pre-stage amplification transistor 315, and a current source transistor 316.

The photoelectric conversion element 311 generates a charge by photoelectric conversion. The transfer transistor 312 transfers the charge from the photoelectric conversion element 311 to the FD 314 according to a transfer signal trg from the vertical selection circuits 25a and b.

The FD reset transistor 313 extracts and initializes charges from the FD 314 in accordance with an FD reset signal rst from the vertical selection circuits 25a and b. The FD 314 accumulates charges, and generates a voltage corresponding to a charge amount. The pre-stage amplification transistor 315 amplifies the level of the voltage of the FD 314 and outputs the amplified voltage to a pre-stage node 320.

Furthermore, the FD reset transistor 313 and the pre-stage amplification transistor 315 have their respective sources connected to a power supply voltage VDD. The current source transistor 316 is connected to a drain of the pre-stage amplification transistor 315. The current source transistor 316 supplies a current id1 under the control of the vertical selection circuits 25a and b. The capacitive elements 321 and 322 have their respective one ends commonly connected to the pre-stage node 320 and have their respective other ends connected to the selection circuit 330.

The selection circuit 330 includes a selection transistor 331 and a selection transistor 332. The selection transistor 331 opens and closes a path between the capacitive element 321 and a post-stage node 340 in accordance with a selection signal or from the vertical selection circuits 25a and b. The selection transistor 332 opens and closes a path between the capacitive element 322 and the post-stage node 340 in accordance with a selection signal Φs from the vertical selection circuits 25a and b.

The post-stage reset transistor 341 initializes the level of the post-stage node 340 to a predetermined potential Vreg in accordance with a post-stage reset signal rstb from the vertical selection circuits 25a and b. A potential different from the power supply potential VDD (for example, a potential lower than VDD) is set as the potential Vreg.

The post-stage circuit 350 includes a post-stage amplification transistor 351, and a post-stage selection transistor 352. The post-stage amplification transistor 351 amplifies the level of the post-stage node 340. In accordance with a post-stage selection signal selb from the vertical selection circuit 25, the post-stage selection transistor 352 outputs a signal at a level amplified by the post-stage amplification transistor 351 to the vertical signal line 26 as a pixel signal. Note that the post-stage amplification transistor is an example of a second amplification transistor recited in the claims.

Note that, for example, n-channel metal oxide semiconductor (nMOS) transistors are used as various transistors (transfer transistor 312 and the like) in the pixel 40.

The vertical selection circuits 25a and b supply the high-level FD reset signal rst and transfer signal trg to all the pixels at the start of exposure. Thus, the photoelectric conversion element 311 is initialized. Hereinafter, this control is referred to as “PD reset”.

Then, the vertical selection circuits 25a and b supply the high-level FD reset signal rst over the pulse period while setting the post-stage reset signal rstb and the selection signal Φr to the high level for all the pixels immediately before the end of the exposure. Therefore, the FD 314 is initialized, and a level according to the level of the FD 314 at that time is held in the capacitive element 321. This control is hereinafter referred to as “FD reset”.

The level of the FD 314 at the time of the FD reset and a level (holding level of the capacitive element 321 and level of the vertical signal line 26) corresponding to the level are collectively referred to as a “P phase” or a “reset level” below.

At the end of the exposure, the vertical selection circuits 25a and b supply the high-level transfer signal trg over the pulse period while setting the post-stage reset signal rstb and the selection signal Φs to the high level for all the pixels. Accordingly, signal charges according to an exposure amount are transferred to the FD 314, and a level according to the level of the FD 314 at that time is held in the capacitive element 322. The level of the FD 314 at the time of transfer of the signal charges and a level (holding level of the capacitive element 322 and level of the vertical signal line 26) corresponding to the level are collectively referred to as a “D phase” or a “signal level” below.

The exposure control of simultaneously starting and ending the exposure for all pixels in this manner is called a global shutter method. Through this exposure control, the pre-stage circuit 310 of all pixels sequentially generates a reset level and a signal level. The reset level is held in the capacitive element 321, and the signal level is held in the capacitive element 322.

After the exposure ends, the vertical selection circuits 25a and b sequentially select rows and sequentially output the reset level and the signal level of the row. At the time of outputting the reset level, the vertical selection circuits 25a and b supply a high-level selection signal Φr over a predetermined period while setting the FD reset signal rst and the post-stage selection signal selb of the selected row to the high level. As a result, the capacitive element 321 is connected to the post-stage node 340, and the reset level is read.

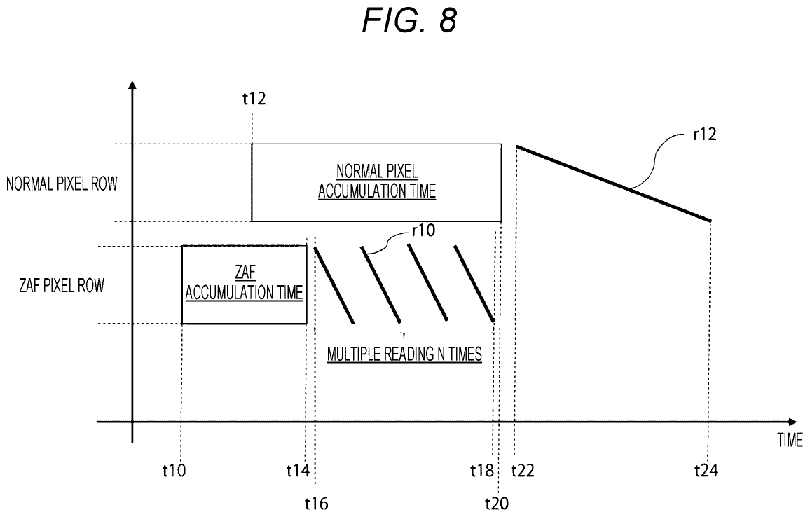

Four control modes of the sensor section 21 will be described with reference to FIGS. 8 to 13. The first mode is a mode in which the reset level and the signal level of each of the phase difference pixels 401 and 402 are repeatedly read N times in order of rows.

The second mode is a mode in which the reset level and the signal level of each of the phase difference pixels 401 and 402 are repeatedly read N times for each row. The third mode is a mode in which the reset level and the signal level of each normal pixel 40 are repeatedly read M times in order of rows. The fourth mode is a mode in which the reset level and the signal level of each of the phase difference pixels 401 and 402 in a limited region of the sensor section 21 are repeatedly read N times in order of rows. Note that the third mode can be combined with the first, second, and fourth modes.

The setting of each mode is set by the imaging control section 13, for example, by an input signal from the operation input section 16. Furthermore, the number of times of reading, N, and M are set by the imaging control section 13 according to an exposure signal of the exposure meter 12a.

### [First Mode]

FIG. 8 is a time chart illustrating a processing example of the normal pixel 40 system and the phase difference pixel 401 and 402 system in the first mode. The horizontal axis represents time, and the vertical axis represents a position of the row of the sensor section 21. The normal pixel 40 and the phase difference pixels 401 and 402 exist in the same row, but for convenience of description, the normal pixel 40 and the phase difference pixels 401 and 402 are separately described.

With reference to FIG. 6, as illustrated in FIG. 8, under the control of the imaging control section 13 (see FIG. 1) and the control section 34 (FIG. 5), the vertical selection circuit 25b (see FIG. 5) supplies the high-level FD reset signal rst and transfer signal trg to the phase difference pixels 401 and 402 at t10, which is the exposure start time of the phase difference pixels 401 and 402. As a result, the photoelectric conversion elements 311 of the phase difference pixels 401 and 402 are initialized. Next, immediately before the exposure end t14, the vertical selection circuit 25b supplies the high-level FD reset signal rst over the pulse period while setting the post-stage reset signal rstb and the selection signal Φr to the high level for all the phase difference pixels 401 and 402. As a result, the FDs 314 of all the phase difference pixels 401 and 402 are initialized, and a level according to the level of the FD 314 at that time is held in the capacitive element 321. Next, at the exposure end time t14, the vertical selection circuit 25b supplies the high-level transfer signal trg over the pulse period while setting the post-stage reset signal rstb and the selection signal Φs to the high level for all the phase difference pixels 401 and 402. Accordingly, signal charges according to an exposure amount are transferred to the FD 314, and a level according to the level of the FD 314 at that time is held in the capacitive element 322.

As indicated by r10, the vertical selection circuit 25b repeats processing of sequentially selecting rows N times between t16 and t18 and sequentially outputting the reset level and the signal level of the row N times. A luminance signal of each of the phase difference pixels 401 and 402 is converted into a digital signal by the ADC 50, associated with (x, y) coordinates, and stored in the memory section 32.

As illustrated in FIG. 5, the data processing section 33 reads image data of the same (x, y) coordinates stored in the memory section 32 N times in a predetermined order, adds the image data, calculates an average value, and then outputs the average value to the imaging control section 13 (FIG. 1) via the IF 38. The imaging control section 13 calculates phase information to control the lens drive section 14.

As described above, the luminance signal of each of the phase difference pixels 401 and 402 is read N times by non-destructive reading, and the average value is calculated. Then, the lens drive section 14 is controlled by the phase information using the average value. Therefore, the level of the random noise of the luminance signal of each of the phase difference pixels 401 and 402 becomes 1/√N times, and the lens drive section 14 is controlled more accurately.

On the other hand, as illustrated in FIG. 8, the vertical selection circuit 25a (see FIG. 5) supplies the high-level FD reset signal rst and transfer signal trg to the normal pixel 40 at time t12 when the exposure of the normal pixel 40 is started. As a result, the photoelectric conversion element 311 of the normal pixel 40 is initialized. Next, immediately before the exposure end t20, the vertical selection circuit 25a supplies the high-level FD reset signal rst over the pulse period while setting the post-stage reset signal rstb and the selection signal Φr to the high level for all the normal pixels 40. As a result, the FDs 314 of all the normal pixels 40 are initialized, and a level corresponding to the level of the FD 314 at that time is held in the capacitive element 321. Next, at the exposure end time t20, the vertical selection circuit 25a supplies the high-level transfer signal trg over the pulse period while setting the post-stage reset signal rstb and the selection signal Φs to the high level for all the normal pixels 40. Accordingly, signal charges according to an exposure amount are transferred to the FD 314, and a level according to the level of the FD 314 at that time is held in the capacitive element 322.

As indicated by r12, the vertical selection circuit 25a sequentially selects a row between t22 and t24, and performs processing of sequentially outputting a reset level (P phase) and a signal level (D phase) of the row once. A luminance signal of each normal pixel 40 is converted into a digital signal by the ADC 50, associated with (x, y) coordinates, and stored in the memory section 32.

As illustrated in FIG. 5 again, the data processing section 33 processes the image data of the same (x, y) coordinates stored in the memory section 32 in a predetermined order, and outputs the processed image data to the imaging control section 13 (FIG. 1) via the IF 38.

### [Second Mode]

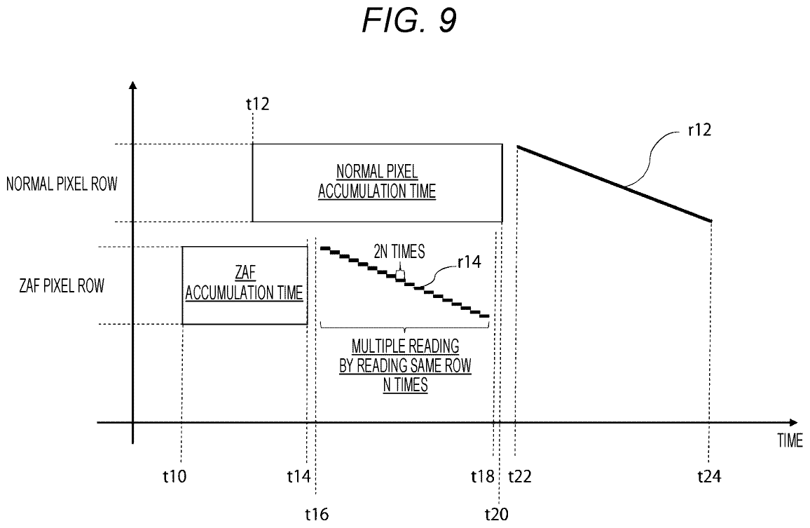

FIG. 9 is a time chart illustrating a processing example of the normal pixel 40 system and the phase difference pixel 401 and 402 system in the second mode. The horizontal axis represents time, and the vertical axis represents a position of the row of the sensor section 21. In the description of the second mode, a difference from the first mode will be described.

As illustrated in FIG. 9, at the exposure end time t14, electrons corresponding to the reset level are held in the capacitive element 321, and electrons corresponding to the signal level are held in the capacitive element 322. As indicated by r14, the vertical selection circuit 25b first reads the reset level (P phase) of the first row N times. At this time, the output value of the comparator 51 (see FIG. 5) varies due to random noise, but the counter section 52 is not reset, and the signals corresponding to the N reset levels are counted. As a result, N reset levels (P phase) are converted into digital signals, and are stored in the memory section 32 in association with the (x, y) coordinates.

Next, as indicated by r14, the vertical selection circuit 25b first reads the signal level (D phase) of the first row N times. At this time, the output value of the comparator 51 (see FIG. 5) varies due to random noise, but the counter section 52 is not reset, and the signals corresponding to the N signal levels are counted. As a result, N signal levels (D phase) are converted into digital signals and stored in the memory section 32 in association with the (x, y) coordinates. Such processing is performed for all rows.

After the N times of data of all rows are read, the data processing section subtracts the N times of signal level (D phase) from the N times of reset level (P phase), implements correlated double sampling (CDS) processing, and then divides by N. As a result, the level of the random noise of the luminance signal of each of the phase difference pixels 401 and 402 becomes 1/VN times, and the lens drive section 14 is controlled more accurately. In a case where such processing is performed, the amount of data stored in the memory section 32 is 1/N of the first mode, so that the storage capacity of the memory section 32 can be reduced.

### [Third Mode]

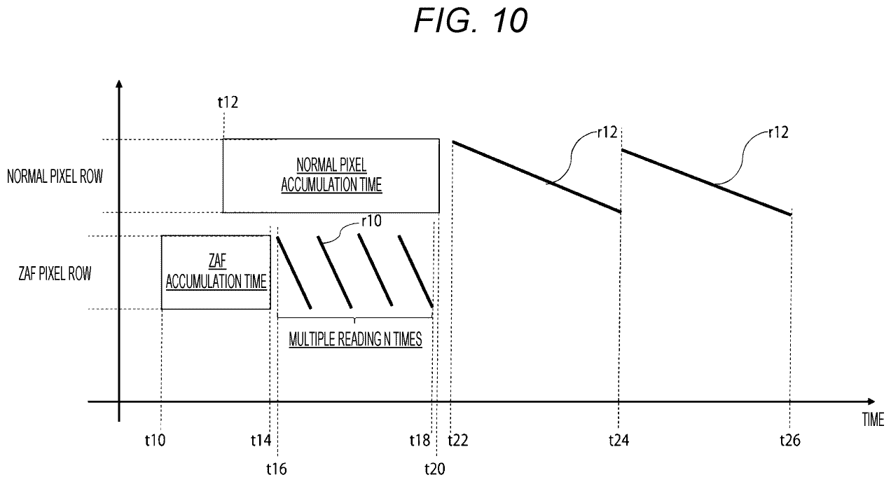

FIG. 10 is a time chart illustrating a processing example in a case where the third mode is executed in addition to the first mode. The horizontal axis represents time, and the vertical axis represents a position of the row of the sensor section 21. As illustrated in FIG. 10, as indicated by r12, the vertical selection circuit 25a sequentially selects a row between t22 and t24 and between t24 and t26, and performs processing of sequentially outputting the reset level (P phase) and the signal level (D phase) of the row twice. A luminance signal of each normal pixel 40 is converted into a digital signal by the ADC 50, associated with (x, y) coordinates, and stored in the memory section 32.

### [Fourth Mode]

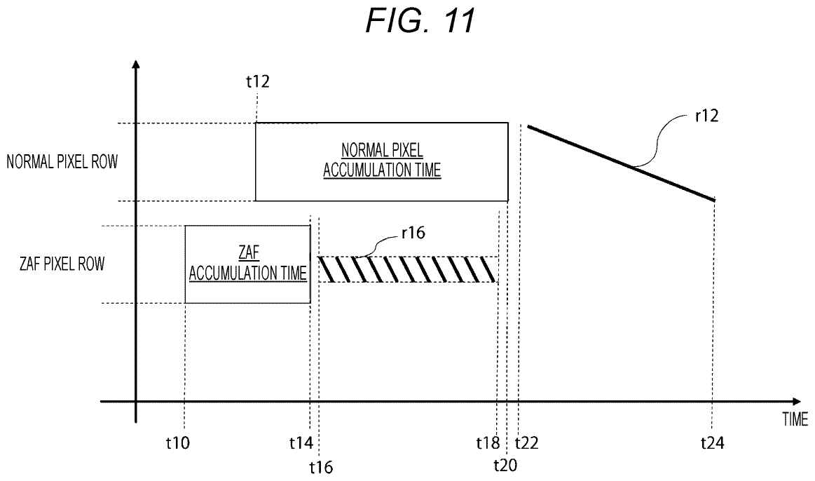

FIG. 11 is a time chart illustrating a processing example in a case where the fourth mode is executed. The horizontal axis represents time, and the vertical axis represents a position of the row of the sensor section 21. As illustrated in FIG. 11, as indicated by r16, the vertical selection circuit 25b repeats processing of sequentially selecting the rows in the region limited range N times and sequentially outputting the reset level and the signal level of the row N times between t16 and t18. A luminance signal of each of the phase difference pixels 401 and 402 is converted into a digital signal by the ADC 50, associated with (x, y) coordinates, and stored in the memory section 32.

As described above, the luminance signal of each of the phase difference pixels 401 and 402 is read N times from the limited range by non-destructive reading at a higher speed, and the average value is calculated. Then, the lens drive section 14 is controlled by the phase information using the average value. Therefore, the level of the random noise of the luminance signal of each of the phase difference pixels 401 and 402 becomes 1/VN times, and the lens drive section 14 is controlled at a higher speed and more accurately.

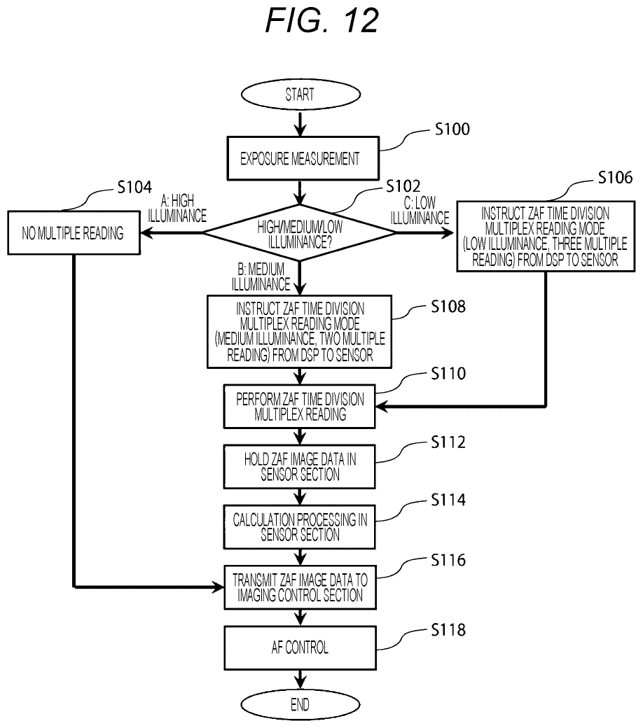

FIG. 12 is a flowchart illustrating an example of control processing of the electronic apparatus 1. Here, an example of control processing in the first mode will be described. As illustrated in FIG. 12, first, the exposure meter 12a generates an exposure value under the control of the imaging control section 13 (step S100).

Next, the imaging control section 13 determines the number of times of reading of each of the phase difference pixels 401 and 402 according to the exposure value (step S102). The imaging control section 13 (DSP) determines high illuminance in a case where the exposure value is higher than a first threshold (A in step S102), performs control processing of not performing multiple reading on the vertical selection circuit 25b via the control section 34 (step S104), and performs processing from step S116.

On the other hand, in a case where the exposure value is lower than a second threshold, the imaging control section 13 determines low illuminance (C in step S102), performs control processing of performing three multiple reading corresponding to the low illuminance, for example, on the vertical selection circuit 25b via the control section 34 (step S106), and performs processing from step S110.

On the other hand, in a case where the exposure value is less than or equal to the first threshold and greater than or equal to the second threshold, the imaging control section 13 determines medium illuminance (B in step S102), performs control processing of performing two multiple reading corresponding to the medium illuminance, for example, on the vertical selection circuit 25b via the control section 34 (step S108), and the vertical selection circuit 25b performs multiple reading processing of each of the phase difference pixels 401 and 402 (step S110).

Next, under the control of the vertical selection circuit 25b, the luminance values read from the phase difference pixels 401 and 402 in a non-destructive manner are held in the memory section 32 (step S112), and addition and average calculation are performed by the data processing section 33 (step S114). Subsequently, the data processing section 33 outputs a calculation processing result of the luminance value read from each of the phase difference pixels 401 and 402 to the imaging control section 13 via the IF 38 in a case where the multiple reading is not performed, and outputs the average value and the calculation processing result to the imaging control section 13 via the IF 38 in a case where the multiple reading is performed (step S116).

Then, the imaging control section 13 calculates phase difference information from the luminance value read from each of the phase difference pixels 401 and 402 or the average value, and performs AF control of the lens 11 according to the phase difference information on the lens drive section 14 (step S118).

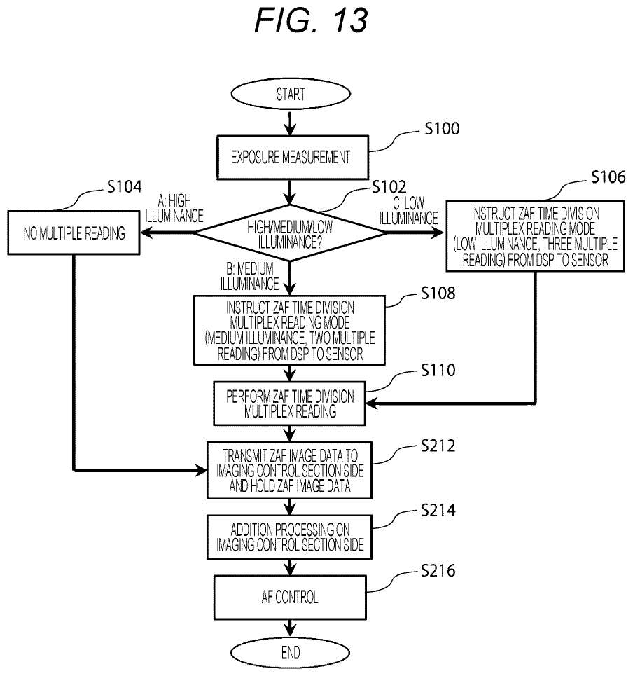

FIG. 13 is a flowchart illustrating an example of control processing of the electronic apparatus 1 in which addition processing in the control processing in the first mode is performed on an imaging control section 13 side. Here, differences from FIG. 13 will be described.

The luminance signal read from each of the phase difference pixels 401 and 402 in a non-destructive manner under the control of the vertical selection circuit 25b is output to the imaging control section 13 by the data processing section 33 (step S212).

Next, the imaging control section 13 calculates the phase difference information from the luminance values read from the phase difference pixels 401 and 402, or calculates the phase difference information after calculating the average value of the multiplexed and read luminance values (step S214).

Then, the imaging control section 13 calculates phase difference information from the luminance values read from the phase difference pixels 401 and 402 or the average value, and performs AF control of the lens 11 according to the phase difference information on the lens drive 14 (step S216).

As described above, according to the present embodiment, an analog signal is read a plurality of times by non-destructive reading under the control of the vertical selection circuit 25b from the phase difference pixels 401 and 402 that detect an image plane phase difference by pupil-dividing incident light from a subject, and the signal processing section 31 converts the analog signal non-destructively read a plurality of times into a digital signal. As a result, random noise of the digital signal is reduced, and focus control of the lens 11 using the digital signal can be performed with higher accuracy.

### 1. Application Example

The technology according to the present disclosure can be applied to various products. For example, the technology according to the present disclosure may also be implemented as a device mounted on any kind of moving body such as an automobile, an electric automobile, a hybrid electric automobile, a motorcycle, a bicycle, a personal mobility, an airplane, a drone, a ship, a robot, a construction machine, an agricultural machine (tractor), or the like.

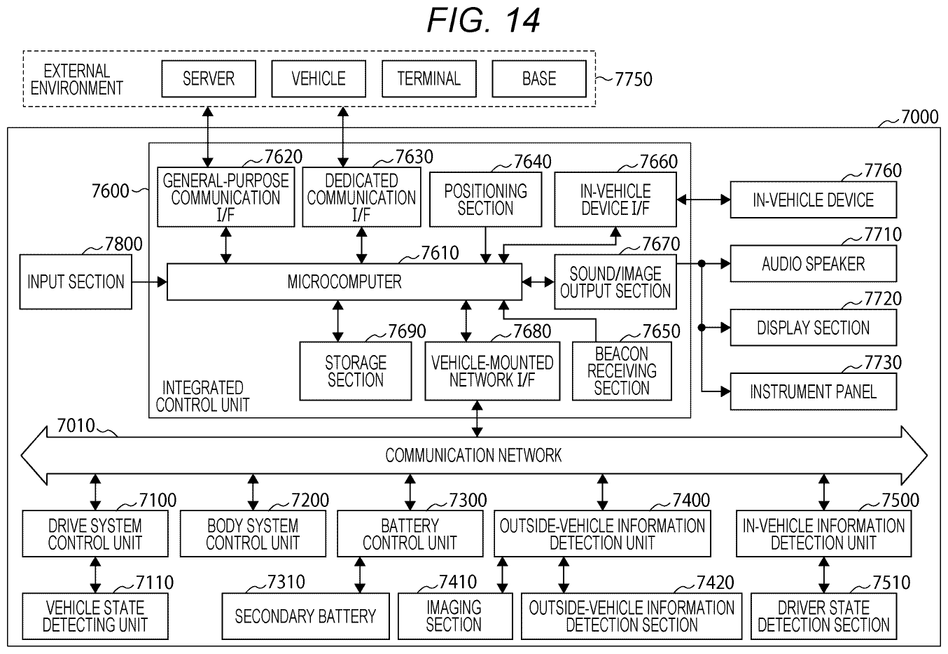

FIG. 14 is a block diagram illustrating a schematic configuration example of a vehicle control system 7000 which is an example of a mobile body control system to which the technology according to the present disclosure can be applied. The vehicle control system 7000 includes a plurality of electronic control units connected to each other via a communication network 7010. In the example illustrated in FIG. 14, the vehicle control system 7000 includes a drive system control unit 7100, a body system control unit 7200, a battery control unit 7300, an outside-vehicle information detection unit 7400, an in-vehicle information detection unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs calculation processing according to various kinds of programs; a storage section that stores the programs executed by the microcomputer, parameters used for various kinds of calculations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. FIG. 14 illustrates, as the functional configuration of the integrated control unit 7600, a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The drive system control unit 7100 controls the operation of devices related to the driving system of the vehicle in accordance with various kinds of programs. For example, the drive system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The drive system control unit 7100 may have a function as a control device of an antilock brake system (ABS), electronic stability control (ESC), or the like.

The drive system control unit 7100 is connected with a vehicle state detection section 7110. The vehicle state detection section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The drive system control unit 7100 performs calculation processing using a signal input from the vehicle state detection section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs calculation processing using these signals, and performs control for regulating the temperature of the secondary battery 7310 or controls a cooling device provided to the battery device or the like.

The outside-vehicle information detection unit 7400 detects information about the outside of the vehicle including the vehicle control system 7000. For example, the outside-vehicle information detection unit 7400 is connected with at least one of an imaging section 7410 and an outside-vehicle information detection section 7420. The imaging section 7410 includes at least one of a time of flight (ToF) camera, a stereo camera, a monocular camera, an infrared camera, and other cameras. The outside-vehicle information detection section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a light detection and ranging or laser imaging detection and ranging (LIDAR) device. Each of the imaging section 7410 and the outside-vehicle information detection section 7420 may be provided as an independent sensor or device, or may be provided as a device in which a plurality of sensors or devices is integrated.

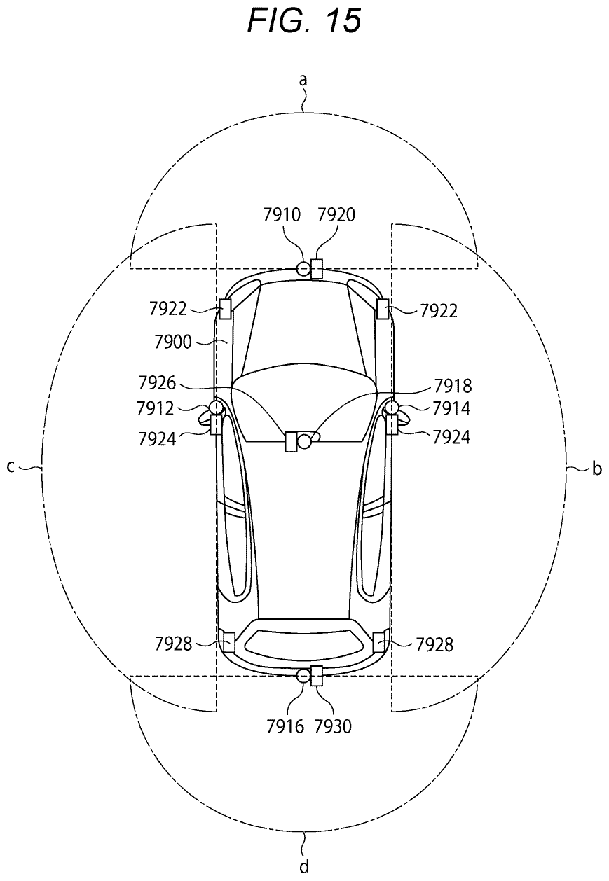

Here, FIG. 15 illustrates an example of installation positions of the imaging section 7410 and the outside-vehicle information detection section 7420. Imaging sections 7910, 7912, 7914, 7916, and 7918 are, for example, disposed at at least one of positions on a front nose, sideview mirrors, a rear bumper, or a back door of the vehicle 7900 or a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided on the sideview mirrors acquire mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Note that FIG. 15 illustrates an example of imaging ranges of the respective imaging sections 7910, 7912, 7914, and 7916. An imaging range a indicates the imaging range of the imaging section 7910 provided on the front nose, imaging ranges b and c indicate the imaging ranges of the imaging sections 7912 and 7914 provided on the sideview mirrors, respectively, and an imaging range d indicates the imaging range of the imaging section 7916 provided on the rear bumper or the back door. A bird's-eye image of the vehicle 7900 as viewed from above can be obtained by superimposing image data captured by the imaging sections 7910, 7912, 7914, and 7916, for example.

Outside-vehicle information detectors 7920, 7922, 7924, 7926, 7928, and 7930 provided on the front, rear, sides, and corners of the vehicle 7900 and the upper portion of the windshield within the interior of the vehicle may be, for example, an ultrasonic sensor or a radar device. The outside-vehicle information detectors 7920, 7926, and 7930 provided on the front nose, the rear bumper, and the back door of the vehicle 7900 and on the upper portion of the windshield within the interior of the vehicle may be, for example, a LIDAR device. These outside-vehicle information detecting sections 7920 to 7930 are used mainly to detect a preceding vehicle, a pedestrian, an obstacle, or the like.

Returning back to FIG. 14, the description will be continued. The outside-vehicle information detection unit 7400 makes the imaging section 7410 image an image of the outside of the vehicle, and receives imaged image data. Furthermore, the outside-vehicle information detection unit 7400 receives detection information from the outside-vehicle information detection section 7420 connected to the outside-vehicle information detection unit 7400. In a case where the outside-vehicle information detection section 7420 is an ultrasonic sensor, a radar device, or a LIDAR device, the outside-vehicle information detection unit 7400 transmits an ultrasonic wave, an electromagnetic wave, or the like, and receives information of a received reflected wave. On the basis of the received information, the outside-vehicle information detection unit 7400 may perform processing of detecting an object such as a human, a vehicle, an obstacle, a sign, a character on a road surface, or the like, or processing of detecting a distance thereto. The outside-vehicle information detection unit 7400 may perform environment recognition processing of recognizing a rainfall, a fog, road surface conditions, or the like on the basis of the received information. The outside-vehicle information detection unit 7400 may calculate a distance to an object outside the vehicle on the basis of the received information.

Furthermore, on the basis of the received image data, the outside-vehicle information detection unit 7400 may perform image recognition processing of recognizing a human, a vehicle, an obstacle, a sign, a character on a road surface, or the like, or processing of detecting a distance thereto. The outside-vehicle information detection unit 7400 may subject the received image data to processing such as distortion correction, alignment, or the like, and combine the image data imaged by different imaging sections 7410 to generate a bird's-eye image or a panoramic image. The outside-vehicle information detection unit 7400 may perform viewpoint conversion processing using the image data imaged by the different imaging sections 7410.

The in-vehicle information detection unit 7500 detects information about the inside of the vehicle. The in-vehicle information detection unit 7500 is, for example, connected with a driver state detection section 7510 that detects the state of a driver. The driver state detection section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detection section 7510, the in-vehicle information detection unit 7500 may calculate a degree of fatigue of the driver or a degree of concentration of the driver, or may determine whether the driver is dozing. The in-vehicle information detection unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Moreover, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, calculation results, sensor values, or the like. Furthermore, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. Furthermore, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Note that incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Note that incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). Furthermore, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. Furthermore, the in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the drive system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. Furthermore, the microcomputer 7610 may perform cooperative control intended for automated driving, which makes the vehicle to travel automatedly without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. Furthermore, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 14, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. Furthermore, in a case where the output device is an audio output device, the audio output device converts an audio signal constituted of reproduced audio data or sound data or the like into an analog signal, and auditorily outputs the analog signal.

Note that in the example illustrated in FIG. 14, at least two control units connected via the communication network 7010 may be integrated as one control unit. Alternatively, each individual control unit may include a plurality of control units. Moreover, the vehicle control system 7000 may include another control unit not depicted in the figures. Furthermore, part or the whole of the functions performed by one of the control units in the above description may be assigned to another control unit. That is, predetermined calculation processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

Note that a computer program for implementing each function of the electronic apparatus 1 according to the present embodiment described with reference to FIG. 1 can be implemented in any of the control units or the like. Furthermore, a computer-readable recording medium in which such a computer program is stored can be provided. The recording medium is, for example, a magnetic disk, an optical disk, a magneto-optical disk, a flash memory, or the like. Furthermore, the computer program described above may be distributed via, for example, a network without using a recording medium.

In the vehicle control system 7000 described above, the electronic apparatus 1 according to the present embodiment described with reference to FIG. 1 can be applied to the integrated control unit 7600 of the application example illustrated in FIG. 14. For example, the electronic device 12 of the electronic apparatus 1 corresponds to the imaging section 7410.

### 2. Application Example

The technology according to the present disclosure can be applied to various products. For example, the technology according to the present disclosure may be applied to an operating room system.

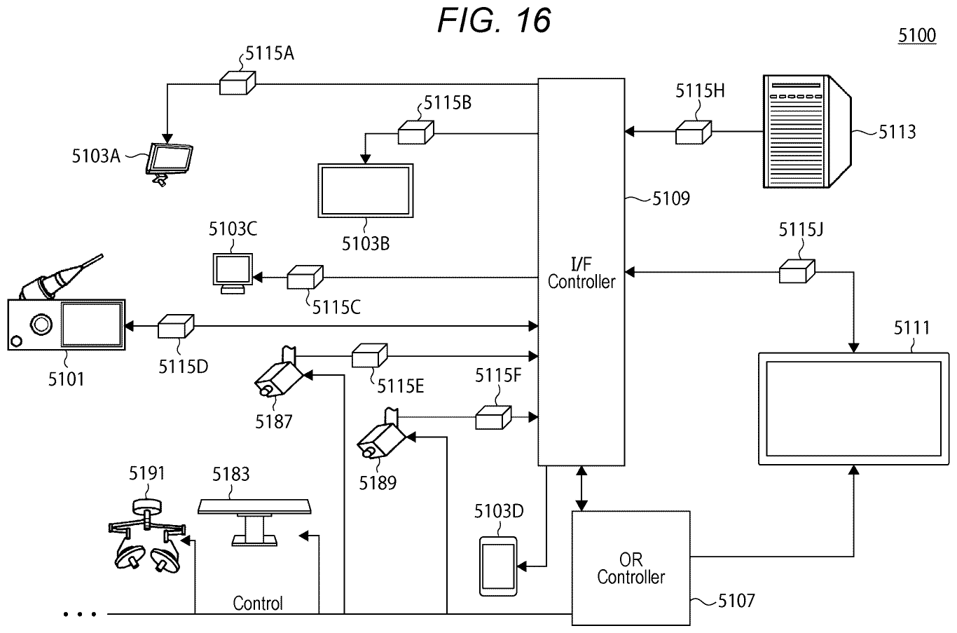

FIG. 16 is a diagram schematically illustrating an overall configuration of an operating room system 5100 to which the technology according to the present disclosure can be applied. Referring to FIG. 16, the operating room system 5100 is configured by connecting a device group installed in an operating room to be able to cooperate with each other via an operating room controller (OR Controller) 5107 and an input/output controller (I/F Controller) 5109. The operating room system 5100 is configured using an Internet Protocol (IP) network capable of transmitting and receiving 4K/8K images, and transmits and receives input and output images and control information for the devices via the IP network.

Various devices can be installed in the operating room. FIG. 16 illustrates, as an example, a group of various devices 5101 for endoscopic surgery, a ceiling camera 5187 that is provided on the ceiling of the operating room and captures an image of the hands of an operator, an operating field camera 5189 that is provided on the ceiling of the operating room and captures an image of the entire operating room, a plurality of display devices 5103A to 5103D, a patient bed 5183, and a light 5191. Note that, in addition to an endoscope illustrated in FIG. 16, various medical devices for acquiring images and videos, such as a master-slave endoscopic surgery robot and an X-ray imaging device, may be applied to the group of devices 5101.

The group of devices 5101, the ceiling camera 5187, the operating field camera 5189, and the display devices 5103A to 5103C are connected to the IF controller 5109 via IP converters 5115A to 5115F (hereinafter, denoted by reference numeral 5115 when not individually distinguished). The IP converters 5115D, 5115E, and 5115F on video source sides (camera sides) perform IP conversion on videos from individual medical image capturing devices (such as an endoscope, an operation microscope, an X-ray imaging device, an operating field camera, and a pathological image capturing device), and transmit the results on the network. The IP converters 5115A to 5115D on video output sides (monitor sides) convert the videos transmitted through the network into monitor-unique formats, and output the results. Note that the IP converters on the video source sides function as encoders, and the IP converters on the video output sides function as decoders. The IP converters 5115 may have various image processing functions, and may have functions of, for example, resolution conversion processing corresponding to output destinations, rotation correction and image stabilization of an endoscopic video, and object recognition processing. Furthermore, the image processing functions may also include partial processing such as feature information extraction for analysis on a server described later. These image processing functions may be specific to the connected medical image devices, or may be upgradable from outside. The IP converters on the display sides can perform processing such as synthesis of a plurality of videos (for example, picture-in-picture (PinP) processing) and superimposition of annotation information. Note that the protocol conversion function of each of the IP converters is a function to convert a received signal into a converted signal conforming to a communication protocol allowing the signal to be transmitted on the network (such as the Internet). Any communication protocol may be set as the communication protocol. Furthermore, the signal received by the IP converter and convertible in terms of protocol is a digital signal, and is, for example, a video signal Φr a pixel signal. Furthermore, the IP converter may be incorporated in a video source side device or in a video output side device.

The group of devices 5101 belong to, for example, an endoscopic surgery system, and include, for example, the endoscope and a display device for displaying an image captured by the endoscope. The display devices 5103A to 5103D, the patient bed 5183, and the light 5191 are, for example, devices equipped in the operating room separately from the endoscopic surgery system. Each of these devices for surgical or diagnostic is also called a medical device. The OR controller 5107 and/or the IF controller 5109 controls operations of the medical devices in cooperation. In a case where the endoscopic surgery robot (surgery master-slave) system and the medical image acquisition devices such as an X-ray imaging device are included in the operating room, those devices can also be connected as the group of devices 5101 in the same manner.

The OR controller 5107 controls processing related to image display in the medical devices in an integrated manner. Specifically, the group of devices 5101, the ceiling camera 5187, and the operating field camera 5189 among the devices included in the operating room system 5100 can each be a device having a function to transmit (hereinafter, also called a transmission source device) information to be displayed (hereinafter, also called display information) during the operation. Furthermore, the display devices 5103A to 5103D can each be a device to output the display information (hereinafter, also called an output destination device). The OR controller 5107 has a function to control operations of the transmission source devices and the output destination devices so as to acquire the display information from the transmission source devices and transmit the display information to the output destination devices to cause the output destination devices to display or record the display information. Note that the display information refers to, for example, various images captured during the operation and various types of information regarding the operation (for example, body information and past examination results of a patient and information about a surgical procedure).

Specifically, information about an image of a surgical site in a body cavity of the patient captured by the endoscope can be transmitted as the display information from the group of devices 5101 to the OR controller 5107. Furthermore, information about an image of the area near the hands of the operator captured by the ceiling camera 5187 can be transmitted as the display information from the ceiling camera 5187. Furthermore, information about an image representing the overall situation in the operating room captured by the operating field camera 5189 can be transmitted as the display information from the operating field camera 5189. Note that, in a case where another device having an imaging function is present in the operating room system 5100, the OR controller 5107 may also acquire information about an image captured by the other device as the display information from the other device.

The OR controller 5107 displays the acquired display information (that is, the images captured during the operation and the various types of information regarding the operation) on at least one of the display devices 5103A to 5103D serving as the output destination devices. In the illustrated example, the display device 5103A is a display device installed on the ceiling of the operating room, being hung therefrom; the display device 5103B is a display device installed on a wall surface of the operating room; the display device 5103C is a display device installed on a desk in the operating room; and the display device 5103D is a mobile device (such as a tablet personal computer (PC)) having a display function.

The IF controller 5109 controls input and output of the video signal from and to connected devices. For example, the IF controller 5109 controls input and output of the video signal on the basis of controlling of the OR controller 5107. The IF controller 5109 includes, for example, an IP switcher, and controls high-speed transfer of the image (video) signal between devices disposed on the IP network.

Furthermore, the operating room system 5100 may include a device outside the operating room. The device outside the operating room can be a server connected to a network built in and outside a hospital, a PC used by a medical staff, or a projector installed in a meeting room of the hospital. In a case where such an external device is present outside the hospital, the OR controller 5107 can also display the display information on a display device of another hospital via, for example, a teleconference system for telemedicine.

Furthermore, an external server 5113 is, for example, an in-hospital server or a cloud server outside the operating room, and may be used for, for example, image analysis and/or data analysis. In this case, the video information in the operating room may be transmitted to the external server 5113, and the server may generate additional information through big data analysis or recognition/analysis processing using artificial intelligence (AI) (machine learning), and feed the additional information back to the display devices in the operating room. At this time, an IP converter 5115H connected to the video devices in the operating room transmits data to the external server 5113, so that the video is analyzed. The transmitted data may be, for example, a video itself of the operation using the endoscope or other tools, metadata extracted from the video, and/or data indicating an operating status of the connected devices.

Moreover, the operating room system 5100 is further provided with a central operation panel 5111. Through the central operation panel 5111, a user can give the OR controller 5107 an instruction about input/output control of the IF controller 5109 and an instruction about an operation of the connected devices. Furthermore, the user can switch image display via the central operation panel 5111. The central operation panel 5111 is configured by providing a touchscreen on a display surface of a display device. Note that the central operation panel 5111 may be connected to the IF controller 5109 via an IP converter 5115J.

The IP network may be established using a wired network, or a part or the whole of the network may be established using a wireless network. For example, each of the IP converters on the video source sides may have a wireless communication function, and may transmit the received image to an output side IP converter via a wireless communication network, such as the fifth-generation mobile communication system (5G) or the sixth-generation mobile communication system (6G).

The technology according to the present disclosure can be suitably applied to the ceiling camera 5187 and the surgical field camera 5189 among the configurations described above.

Note that the present technology may have the following configurations.

(1)

A solid-state imaging element including:
first phase difference pixels, each pupil-dividing incident light from a subject and detecting an image plane phase difference;
a control circuit that controls driving of the first phase difference pixels; and
a signal processing section that converts an analog signal non-destructively read a plurality of times from each of the first phase difference pixels into a digital signal according to control of the control circuit.
   (2)

The solid-state imaging element according to (1), further including a sensor section including a plurality of phase difference pixels including the first phase difference pixels and a plurality of pixels used for imaging.

(3)

The solid-state imaging element according to (2), in which the control circuit limits the phase difference pixels to be subjected to non-destructive reading within a predetermined region in the sensor section.

(4)

The solid-state imaging element according to (2), in which
the signal processing section includes:
an analog-to-digital converter that converts an analog signal non-destructively read from each of the first phase difference pixels into a digital signal; and
a data processing section that performs calculation processing on the digital signal converted by the analog-to-digital converter,
the analog-to-digital converter converts analog signals non-destructively read a plurality of times into digital signals, and
the data processing section performs addition processing on a plurality of the converted digital signals.
   (5)

The solid-state imaging element according to (4), in which the control circuit changes a number of times of non-destructive reading from the first phase difference pixels.

(6)

The solid-state imaging element according to (5), in which the control circuit changes a number of times of non-destructive reading from the plurality of pixels.

(7)

The solid-state imaging element according to (5) or (6), in which the control circuit changes a number of times of the non-destructive reading on the basis of an exposure signal related to a light reception amount.

(8)

The solid-state imaging element according to (7), in which
the plurality of phase difference pixels and the plurality of pixels used for imaging are arranged in a matrix, and
the control circuit is capable of controlling the phase difference pixels arranged in a same row or a same column and the pixels to accumulate charges according to a light reception amount at different accumulation times.
   (9)

The solid-state imaging element according to (2), in which
the signal processing section includes
an analog-to-digital converter that converts an analog signal non-destructively read from each of the first phase difference pixels into a digital signal, and
the analog-to-digital converter includes:
a comparator that compares a level of the non-destructively read analog signal with a predetermined ramp signal and outputs a comparison result; and
a counter section that counts a count value over a period until the comparison result is inverted and outputs the digital signal indicating the count value.
   (10)

The solid-state imaging element according to (9), in which the counter section adds the count value for each of analog signals non-destructively read a plurality of times.

(11)

The solid-state imaging element according to (2), in which a predetermined range of a light receiving region of each of the first phase difference pixels is shielded from light.

(12)

The solid-state imaging element according to (2), in which the first phase difference pixels include one of two adjacent pixels in which an elliptical on-chip lens is disposed.

(13)

The solid-state imaging element according to (2), in which the first phase difference pixels include at least one of four adjacent pixels in which color filters of a same color are disposed.

(14)

The solid-state imaging element according to (2), in which the first phase difference pixels include at least one of four adjacent pixels in which one on-chip lens is disposed.

(15)

The solid-state imaging element according to (2), in which the first phase difference pixels include at least one of two adjacent square shaped pixels in which one on-chip lens is disposed.

(16)

The solid-state imaging element according to (2), in which the plurality of pixels is imaged via a polarization section that changes light.

(17)

The solid-state imaging element according to (2), in which
the signal processing section includes:
an analog-to-digital converter that converts an analog signal non-destructively read from each of the first phase difference pixels into a digital signal; and
a transmission section that transmits the digital signal,
the analog-to-digital converter converts analog signals non-destructively read a plurality of times into digital signals, and
the transmission section transmits a plurality of the converted digital signals.
   (18)

The solid-state imaging element according to (9), in which
each of the first phase difference pixels includes:
first and second capacitive elements;
a pre-stage circuit that sequentially generates a predetermined reset level and a signal level according to an exposure amount and causes each of the first and second capacitive elements to hold the reset level and the signal level; and
a post-stage circuit that sequentially reads and outputs the reset level and the signal level from the first and second capacitive elements.
   (19)

The solid-state imaging element according to (18), in which the comparator compares a level of a signal line that transmits the reset level and the signal level with a predetermined ramp signal, and outputs a comparison result.

(20)

An electronic apparatus including:
the solid-state imaging element according to (1);
a lens that condenses light from a subject and condenses the light on a light receiving surface on which the first phase difference pixels are disposed; and
an imaging control section that controls a focal position of the lens according to a signal generated by the signal processing section.

Aspects of the present disclosure are not limited to the above-described individual embodiments, but include various modifications that can be conceived by those skilled in the art, and the effects of the present disclosure are not limited to the above-described contents. That is, various additions, modifications, and partial deletions are possible without departing from the conceptual idea and spirit of the present disclosure derived from the matters defined in the claims and equivalents thereof.

### REFERENCE SIGNS LIST

1 Electronic apparatus
11 Lens
12 Electronic device (solid-state imaging element)
13 Imaging control section
26 Signal line
33 Interface section
40 Normal pixel
50 Analog-to-digital converter
51 Comparator
52 Counter section
310 Pre-stage circuit
150 Polarization section
321, 322 Capacitive element
350 Post-stage circuit
401 to 401e Phase difference pixel
402 to 402e Phase difference pixel

1. A solid-state imaging element comprising:
first phase difference pixels, each pupil-dividing incident light from a subject and detecting an image plane phase difference;
a control circuit that controls driving of the first phase difference pixels; and
a signal processing section that converts an analog signal non-destructively read a plurality of times from each of the first phase difference pixels into a digital signal according to control of the control circuit.

2. The solid-state imaging element according to claim 1, further comprising a sensor section including a plurality of phase difference pixels including the first phase difference pixels and a plurality of pixels used for imaging.

3. The solid-state imaging element according to claim 2, wherein the control circuit limits the phase difference pixels to be subjected to non-destructive reading within a predetermined region in the sensor section.

4. The solid-state imaging element according to claim 2, wherein
the signal processing section includes:
an analog-to-digital converter that converts an analog signal non-destructively read from each of the first phase difference pixels into a digital signal; and
a data processing section that performs calculation processing on the digital signal converted by the analog-to-digital converter,
the analog-to-digital converter converts analog signals non-destructively read a plurality of times into digital signals, and
the data processing section performs addition processing on a plurality of the converted digital signals.

5. The solid-state imaging element according to claim 4, wherein the control circuit changes a number of times of non-destructive reading from the first phase difference pixels.

6. The solid-state imaging element according to claim 5, wherein the control circuit changes a number of times of non-destructive reading from the plurality of pixels.

7. The solid-state imaging element according to claim 5, wherein the control circuit changes a number of times of the non-destructive reading based on an exposure signal related to a light reception amount.

8. The solid-state imaging element according to claim 7, wherein
the plurality of phase difference pixels and the plurality of pixels used for imaging are arranged in a matrix, and
the control circuit is capable of controlling the phase difference pixels arranged in a same row or a same column and the pixels to accumulate charges according to a light reception amount at different accumulation times.

9. The solid-state imaging element according to claim 2, wherein
the signal processing section includes
an analog-to-digital converter that converts an analog signal non-destructively read from each of the first phase difference pixels into a digital signal, and
the analog-to-digital converter includes:
a comparator that compares a level of the non-destructively read analog signal with a predetermined ramp signal and outputs a comparison result; and
a counter section that counts a count value over a period until the comparison result is inverted and outputs the digital signal indicating the count value.

10. The solid-state imaging element according to claim 9, wherein the counter section adds the count value for each of analog signals non-destructively read a plurality of times.

11. The solid-state imaging element according to claim 2, wherein a predetermined range of a light receiving region of each of the first phase difference pixels is shielded from light.

12. The solid-state imaging element according to claim 2, wherein the first phase difference pixels include one of two adjacent pixels in which an elliptical on-chip lens is disposed.

13. The solid-state imaging element according to claim 2, wherein the first phase difference pixels include at least one of four adjacent pixels in which color filters of a same color are disposed.

14. The solid-state imaging element according to claim 2, wherein the first phase difference pixels include at least one of four adjacent pixels in which one on-chip lens is disposed.

15. The solid-state imaging element according to claim 2, wherein the first phase difference pixels include at least one of two adjacent square shaped pixels in which one on-chip lens is disposed.

16. The solid-state imaging element according to claim 2, wherein the plurality of pixels is imaged via a polarization section that changes light.

17. The solid-state imaging element according to claim 2, wherein
the signal processing section includes:
an analog-to-digital converter that converts an analog signal non-destructively read from each of the first phase difference pixels into a digital signal; and
a transmission section that transmits the digital signal,
the analog-to-digital converter converts analog signals non-destructively read a plurality of times into digital signals, and
the transmission section transmits a plurality of the converted digital signals.

18. The solid-state imaging element according to claim 9, wherein
each of the first phase difference pixels includes:
first and second capacitive elements;
a pre-stage circuit that sequentially generates a predetermined reset level and a signal level according to an exposure amount and causes each of the first and second capacitive elements to hold the reset level and the signal level; and
a post-stage circuit that sequentially reads and outputs the reset level and the signal level from the first and second capacitive elements.

19. The solid-state imaging element according to claim 18, wherein the comparator compares a level of a signal line that transmits the reset level and the signal level with a predetermined ramp signal, and outputs a comparison result.

20. An electronic apparatus comprising:
the solid-state imaging element according to claim 1;
a lens that condenses light from a subject and condenses the light on a light receiving surface on which the first phase difference pixels are disposed; and
an imaging control section that controls a focal position of the lens according to a signal generated by the signal processing section.
